(19) United States
(12) Patent Application Publication
(10) Pub. No.: US 2003/0033371 A1
(43) Pub. Date: Feb. 13, 2003

(54) Information output service system

(76) Inventor: Masaaki Ueno, Chiyoda-ku (JP)

Correspondence Address: Bruce S. Londa, Norris McLaughlin & Marcus, P.A., 220 East 42nd Street - 30th Floor, New York, NY, 10017, US

(21) Appl. No.: 09/955,859

(22) Filed: Sep. 19, 2001

(30) Foreign Application Priority Data
Aug. 8, 2001 (JP) P2001-241111

(51) Int. Cl. G06F 15/16; G06F 17/60

(52) U.S. Cl. 709/206; 705/1

(57) ABSTRACT

After an e-mail address has been designated from a portable terminal and an e-mail and its attachment file have been transmitted together to a mail server, the e-mail address, an ID, a password, and the like are input via an input device of fixed terminals installed at various stores which the public can make use of. The e-mail and its attachment file at the e-mail address are then extracted from the mail server and are printed out at the fixed terminals.

### BACKGROUND OF THE INVENTION

1. Field of the Invention

The present invention relates to a convenient information output service system in which the contents of an e-mail and its attachment file created or received in a portable terminal such as a mobile phone or a PDA (Personal Digital Assistant) can be easily printed out even away from home, thereby allowing the contents of the attachment file or the like to be easily read and used.

2. Description of the Related Art

Recently, as the Internet has rapidly come into widespread use, and more particularly, as mobile phones are rapidly becoming common and are Internet-capable, the number of users of mobile phones has increased. Accordingly, various portable terminals such as mobile phones, PDAS, and notebook-sized personal computers having mail-transmitting and -receiving functions capable of transmitting and receiving e-mail via the Internet are on the market, and e-mail messages transmitted and received by these functions are frequently used everyday.

However, in the above-described conventional portable terminals such as mobile phones, since a screen for displaying the contents of the e-mail or the like is small, the contents of an e-mail including a lot of text are particularly difficult to read.

Also, since the contents of the e-mail cannot be printed out by a conventional portable terminal itself, a personal computer or a device specifically designed for printing is required, which causes inconvenience when away from home. For example, when a user goes out from the company without documents, sometimes he has the documents transmitted from the company to the portable terminal by e-mail. In this case, in the conventional portable terminal, the contents of the e-mail cannot be printed out away from the company if there is no printer or personal computer. Thus, the transmitted e-mail documents cannot be effectively used.

Furthermore, recently, mobile phones equipped with a compact digital camera have gradually become popular. In this type of mobile phone equipped with a digital camera, there is a certain limit to the number of images which can be photographed and stored by the digital camera because of the capacity of an image memory in the mobile phone for storing images photographed by the digital camera. Accordingly, a large number of images cannot be photographed at a time.

### SUMMARY OF THE INVENTION

The present invention is made to solve the above problems. Accordingly, it is an object of the present invention to provide a convenient information output service system in which the contents of an e-mail and its attachment file which are created and received in a portable terminal can be easily printed out even away from home, thereby allowing the contents of the attachment file or the like to be easily read and effectively used.

In order to achieve the above object, the information output service system according to the present invention comprises a mail server connected to the Internet, a portable terminal, and a plurality of fixed terminals, wherein, the mail server has the function of storing and managing an e-mail transmitted via the Internet, wherein, the portable terminal has the function of designating an e-mail address and transmitting the e-mail and an attachment file together to the mail server; and wherein, the fixed terminals are installed at stores which the public can make use of, and the system is provided with an input device for inputting personal information such as an e-mail address and an ID, a mail extracting unit for extracting the e-mail and its attachment file at the corresponding e-mail address from the mail server via the Internet based on the input personal information when the personal information is input via the input device, and a printer for printing the contents of the extracted e-mail or the attachment file.

In the present invention, when the e-mail address is designated from the portable terminal and the e-mail and its attachment file are transmitted together to the mail server, the e-mail and the attachment file at the corresponding e-mail address are extracted from the mail server and can be printed out at the fixed terminals installed at various stores which the public can make use of.

The portable terminal is any one of a portable phone, a PHS (Personal Handy-phone System), a notebook-sized personal computer, and a PDA (Personal Digital Assistant).

The attachment file of the e-mail is any one of a document converted into digital data and an image such as a photograph, wherein the image may be a still image or moving images.

Preferably, the portable terminal further has the function of photographing a still image with a digital camera and the function of transmitting a still image photographed by the digital camera to the mail server as the attachment file of the e-mail.

In the structure in which the still image photographed by the digital camera is set as the attachment file, as described above, preferably, (1) every time a still image is photographed by the digital camera, the still camera photographed by the digital camera is immediately transmitted to the mail server as the attachment file of the e-mail. Alternatively, (2) the portable terminal may be provided with an image memory capable of storing a plurality of still images photographed by the digital camera in individual files, and wherein, when a predetermined number of the still images are stored in the image memory, the predetermined number of still images are transmitted together at one time to the mail server as the attachment file of the e-mail.

Preferably, the portable terminal further has the function of photographing moving images with a digital camera, and the function of transmitting moving images photographed by the digital camera to the mail server as the attachment file of the e-mail.

In the structure in which the moving images photographed by the digital camera are set as the attachment file, as described above, preferably, the moving images photographed by the digital camera are continuously transmitted to the mail server as the attachment file of the e-mail while the digital camera is performing the operation of photographing the moving images.

Preferably, each of the fixed terminals further comprises a data recorder for recording the contents of the e-mail or the attachment file on recording media such as a digital video tape, a CD-R (Compact Disc-Recordable), and a DVD (Digital Versatile Disc).

Preferably, the present invention further comprises a Web site for obtaining an account for using the mail server, wherein, when obtaining the account at the Web site, the user is charged for the use of this system.

Preferably, the fixed terminal further includes a display, wherein an advertisement is displayed on the display of the fixed terminal when the fixed terminal is idle.

### BRIEF DESCRIPTION OF THE DRAWINGS

FIG. 1 is a block diagram of a system network showing an embodiment of an information output service system according to the present invention; and

FIG. 2 is a block diagram of a fixed terminal in the information output service system shown in FIG. 1.

### DESCRIPTION OF THE PREFERRED EMBODIMENTS

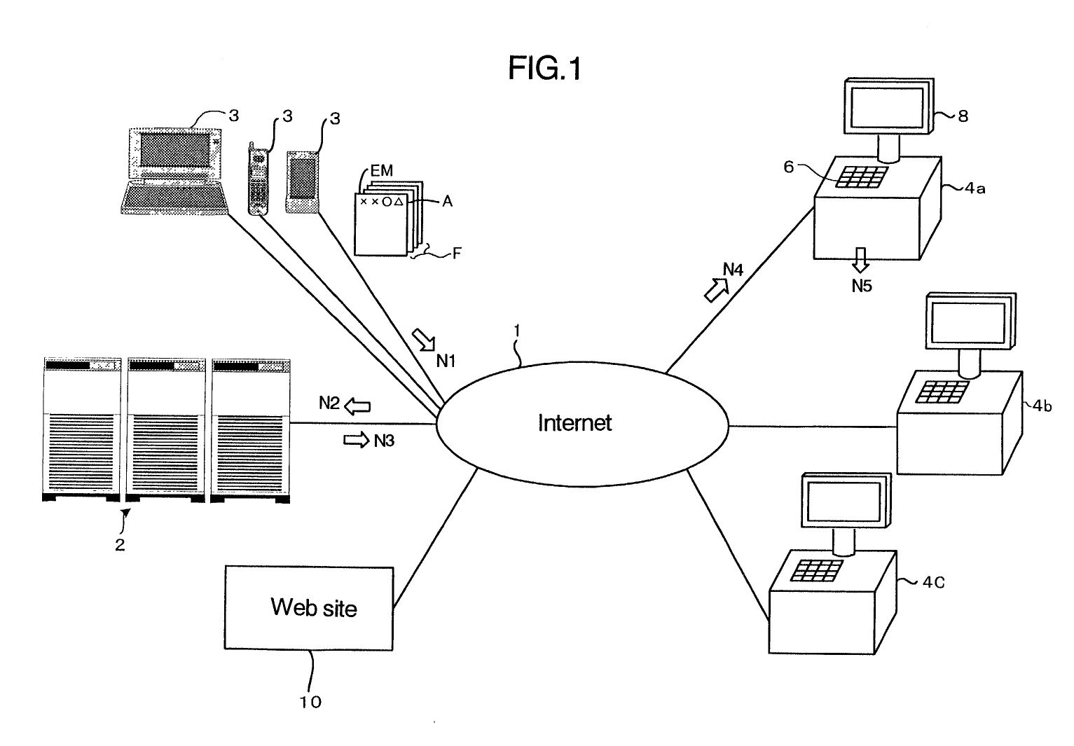

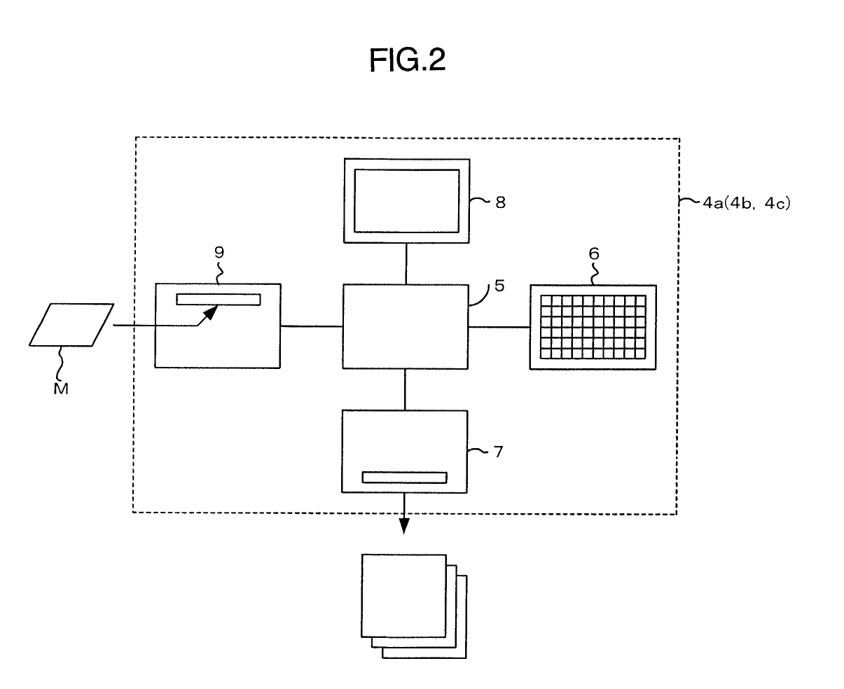

Referring to FIGS. 1 and 2, an embodiment of an information output service system according to the present invention will be specifically described hereinbelow.

FIG. 1 shows an information output service system composed of a system network using the Internet 1, which includes a mail server 2, a portable terminal 3, and a plurality of fixed terminals 4a, 4b, . . . which are connected thereto.

The mail server 2 has the function of storing and managing e-mails EM transmitted via the Internet 1.

The portable terminal 3 has the function of designating an e-mail address A and transmitting the e-mails EM with an attachment file F to the mail server 2, the function of receiving the e-mail EM transmitted via the Internet 1, the function of creating the e-mail EM, and the like. The portable terminal 3 having such various functions may be a mobile phone, a PHS, a notebook-sized personal computer, a PDA, or the like.

The attachment file F transmitted together with the e-mail EM from the portable terminal 3 includes documents converted into digital data and images such as a photograph.

The attachment file F transmitted together with the e-mail EM from the portable terminal 3 may be a document file transmitted to the portable terminal 3 via the Internet 1 or a document file created using the mail creating function of the portable terminal 3.

The portable terminal 3 of this embodiment is equipped with a digital camera (not shown) and also has the function of photographing a still image using the digital camera. In this embodiment having such a configuration, the attachment file F transmitted together with the e-mail EM from the portable terminal 3 includes a file of the still image photographed by the digital camera of the portable terminal 3 as well as a file of a still image transmitted to the portable terminal 3 via the Internet 1.

In other words, in the portable terminal 3 of this embodiment, the still image can be photographed by the digital camera mounted thereon, and the photographed still image can be transmitted to the mail server 2 as the attachment file F of the e-mail EM.

At least one of the fixed terminals 4a, 4b, . . . is installed at each of various stores in Japan and around the world, such as in convenience stores and amusement arcades, which the public can make use of. If necessary, the fixed terminals 4a, 4b, . . . may be installed on street corners.

As shown in FIG. 2, each of the plurality of fixed terminals 4a, 4b, . . . installed at the various stores, as described above, is configured as multipurpose output terminal equipment, and is equipped with a personal computer 5 which can be connected to the Internet 1, a mail extracting unit, an input device 6 having various input keys, a printer 7, and a display 8 having a liquid crystal display unit and the like.

The input device 6 of the fixed terminals 4a, 4b, . . . is configured in such a manner as to input personal information such as an e-mail address, an ID, and a password.

In this embodiment, the mail extracting function of the fixed terminals 4a, 4b, . . . is executed by the personal computer 5 mounted thereon. In other words, when the above-described personal information (the e-mail address A, the ID, the password, and the like) is input via the input device 6, the personal computer 5 of the fixed terminals 4a, 4b, . . . can extract the e-mail EM and its attachment file F of the corresponding e-mail address A from the mail server 2 via the Internet based on the input personal information.

The printer 5 of the fixed terminals 4a, 4b, . . . is configured in such a manner as to print out the contents of the extracted e-mail EM and the attachment file F.

On the display 8 of the fixed terminals 4a, 4b, . . . , a method for operating each fixed terminal, the usage of this system, and the like can be displayed, and also advertisements can be displayed while the fixed terminals 4a, 4b, . . . are idle.

Furthermore, each of the fixed terminals 4a, 4b, . . . is provided with a data recorder 9 for recording the contents of the e-mail EM or the attachment file F in recording media M such as a digital videotape, a CD-R, and a DVD.

When the information output service system of this embodiment is used in practice, it is necessary to obtain an account for using the mail server 2, which can be obtained at a specific Web site 10 via the Internet 1.

In this embodiment, when the account is obtained at the specific Web site 10, a user is charged for use of this system, and the e-mail address A, the ID, and the password are issued thereto.

Referring to FIG. 1, an example of using the information output service system with the above configuration will be described. In FIG. 1, reference numerals N1 to N4 and the arrows indicate the order of transmitting the e-mail and the direction of transmission. Reference numeral N5 and the arrow represent printing-out.

A person who wants to use this information output service system first makes access to the specific Web site 10 from the portable terminal 3, a personal computer at home or at work, or the like via the Internet 1, and obtains an account for using the mail server 2 at a homepage of the Web site 10. When the user obtains the account, as described above, the e-mail address A, the ID, the password, and the like are issued to the user, thereby allowing the user to use the mail server 2. When the e-mail address A and the like are issued, the user is charged for use of this system.

After obtaining the account, the user can make a stop at various stores where the fixed terminals 4a, 4b, . . . are installed, such as the nearest convenience store or amusement arcade, and can print out necessary information from the portable terminal 3. Such printing-out can be performed according to the following steps:

Specifically, as an example of information to be printed out, a still image photographed by the digital camera of the portable terminal 3 is stored in the portable terminal 3. (1) The user designates the e-mail address A and transmits the e-mail EM to the mail server 2 via the Internet 1, as shown in FIG. 1. At this time, the image photographed by the digital camera of the portable terminal 3 is attached to the e-mail EM as the attachment file F. Subsequently, (2) the user inputs the personal information such as an e-mail address A, an ID, and a password via the input device 6 of any one (in this example, the fixed terminal 4a) of the plurality of fixed terminals 4a, 4b, . . . .

Accordingly, in the fixed terminal 4a, the corresponding e-mail EM and the attachment file F are extracted from the mail server 2 via the Internet 1 based on the input information. Also, the contents of the extracted e-mail EM and the attachment file F, that is, the image (still image) photographed by the digital camera of the portable terminal 3, are printed out on paper by the printer 5. When necessary, the contents of the extracted e-mail EM and the attachment file F can also be recorded in recording media M such as a digital video tape, a CD-R, and DVD in the data recorder 9 of the fixed terminal 4a at the same time as printing.

In the above example, while the example of printing-out at the fixed terminal 4a is described, printing-out can also be performed at the other fixed terminals 4b and 4c according to steps (1) and (2). Also, in the above example, while the example of printing out the contents of the e-mail EM and the attachment file F is given, the contents of the e-mail EM may be omitted and only the contents of the attachment file F, that is, the image photographed by the digital camera of the portable terminal 3, may be printed out.

As the information to be printed out, it may be an image and a document transmitted to the portable terminal 3 as the attachment file F of the e-mail EM via the Internet 1, the contents of the e-mail EM created by the mail creating function of the portable terminal 3, and the contents of the e-mail EM transmitted to the portable terminal 3 via the Internet 1 as well as the image photographed by the digital camera of the portable terminal 3, as described above. Such images and documents can also be printed out according to steps (1) and (2).

Furthermore, in the portable terminal 3, music data and games delivered via the Internet 1 can also be downloaded. In this case, when lyrics, game manuals, or the like are attached thereto, this type of associated information can also be printed out according to steps (1) and (2) above.

As described above, the information output service system of this embodiment is configured in such a way that, when the e-mail address A is designated and the e-mail EM and the attachment file F are transmitted from the portable terminal 3 to the mail server 2, the e-mail EM and the attachment file F at the e-mail address A can be extracted from the mail server 2 and can be printed out in the fixed terminals 4a, 4b, . . . installed at various stores which the public can make use of. Accordingly, the contents of the e-mail EM and the attachment file F received at the portable terminal 3 can be easily printed out any time at various stores, even away from home, thus allowing the contents of the attachment file F or the like to be easily read and utilized effectively. Also, by simply transmitting the contents of the e-mail EM and the attachment file F to the mail server 2, the contents thereof can be printed out even when there is no portable terminal 3.

Since the information output service system of this embodiment is configured in such a manner that the image photographed by the digital camera of the portable terminal 3 applies to the attachment file F of the e-mail EM to be transmitted from the portable terminal 3 to the mail server 2, as described above, such an image photographed by the digital camera of the portable terminal 3 can also be easily printed out any time at various stores, and also a DPE (developing, printing, and enlarging) service can be performed.

In the information output service system of this embodiment, since the image photographed by the digital camera of the portable terminal 3 can be printed out at any desired time at the fixed terminals 4a, 4b, . . . of the various stores as long as it exists in the mail server 2 as the attachment file F of the e-mail EM, there is no need to store the image in the image memory of the portable terminal 3 until performing printing-out. By repeating a series of operations, that is, (1) photographing the image, (2) transmitting the photographed image, and (3) deleting the transmitted image, any number of still images can be photographed and printed out irrespective of the capacity of the image memory in the portable terminal 3 for storing the image photographed by the digital camera.

Furthermore, when the specific Web site 10 is registered at a portal site of a telephone company, all charges for use of this system are billed to the user of this system as the charge for use of this system when telephone charges are billed. Accordingly, in this case, the fixed terminals 4a, 4b, . . . do not receive the charge for use of this system. Accordingly, troublesome sales collecting work can be avoided, thereby decreasing the cost of operating the system.

As a method for sending the e-mail EM and its attachment file F from the portable terminal 3 to the mail server 2, one of the following methods can be adopted: (1) a manual method in which transmission is performed by clicking a mail-transmitting button of the portable terminal 3; (2) a method in which transmission is automatically performed in synchronization with photographing a still image with the digital camera of the portable terminal 3, for example, a method in which, every time a still image is photographed by the digital camera of the portable terminal 3, it is immediately transmitted to the mail server 2 as the attachment file F of the e-mail EM; and (3) a method in which, when the portable terminal 3 is provided with an image memory capable of storing a plurality of still images photographed by the digital camera in individual files, a predetermined number of the still images are automatically transmitted to the mail server 2 at one time as attachment files F of the e-mail EM when the predetermined number of still images are stored in the image memory.

Particularly, in the automatic transmission method (2) described above, it is sufficient that the portable terminal 3 has an image memory which stores at least one still image until it is transmitted, thereby significantly reducing the required capacity of the image memory.

In this embodiment, while a case in which the still image is photographed by the digital camera of the portable terminal 3 is described, this type of portable terminal 3 may be provided with the function of photographing moving images with the digital camera as well as still images, and the function of transmitting the photographed moving images to the mail server 2 as the attachment file F of the e-mail EM. The portable terminal 3 which handles the moving images may be configured in such a manner that the moving images photographed by the digital camera can also be continuously transmitted to the mail server 2 as the attachment file F of the e-mail EM while the digital camera is performing the moving-image photographing operation. In this case, the attachment file F of the e-mail EM extracted by the fixed terminals 4a, 4b, . . . is the moving images, and this type of moving images may be recorded on a digital video tape or the like by the data recorder 9 of the fixed terminals 4a, 4b, . . . . Alternatively, it may be arranged that one scene of the moving images is appropriately selected and is printed out on paper by the printer 5 of the fixed terminals 4a, 4b.

In the information output service system according to the present invention, when the e-mail address is designated from the portable terminal and the e-mail and its attachment file are transmitted together to the mail server, the e-mail and its attachment file at the e-mail address are extracted from the mail server and can be printed out at the fixed terminals installed at various stores which the public can make use of. Accordingly, the contents of the e-mail and its attachment file received by the portable terminal can be easily printed out any time at the various stores, even when away from home, thus allowing the contents of the attachment file or the like to be easily read and thereby to be effectively used. Also, as long as the e-mail and its attachment file are transmitted to the mail server in advance, the contents of the attachment file or the like can be printed out even without the portable terminal; thus it is convenient.

### CLAIM TO PRIORITY

Priority is hereby claimed under 35 U.S.C. 119 on the basis of Japanese Application Serial No. P2001-241 111, filed on Aug. 8, 2000

What is claimed is:

1. An information output service system comprising:
a mail server connected to the Internet;
a portable terminal; and
a plurality of fixed terminals,
wherein, the mail server has the function of storing and managing an e-mail transmitted via the Internet;
wherein, the portable terminal has the function of designating an e-mail address and transmitting the e-mail and an attachment file together to the mail server; and
wherein, the fixed terminals are installed at stores which the public can make use of, each of the fixed terminals comprising:
input means for inputting personal information such as an e-mail address and an ID;
mail extracting means for extracting the e-mail and its attachment file at the corresponding e-mail address from the mail server via the Internet based on the input personal information when the personal information is input via the input means; and
a printer for printing the contents of the extracted e-mail or the attachment file.

2. The information output service system according to claim 1, wherein:
the portable terminal is any one of a portable phone, a PHS, a notebook-sized personal computer, and a PDA.

3. The information output service system according to claim 1, wherein:
the attachment file of the e-mail is a document converted into digital data or an image such as a photograph.

4. The information output service system according to claim 1, wherein:
the portable terminal further has the function of photographing a still image with a digital camera and the function of transmitting a still image photographed by the digital camera to the mail server as the attachment file of the e-mail.

5. The information output service system according to claim 4, wherein:
every time a still image is photographed by the digital camera, the still image photographed by the digital camera is immediately transmitted to the mail server as the attachment file of the e-mail.

6. The information output service system according to claim 4,
wherein, the portable terminal is provided with an image memory capable of storing a plurality of still images photographed by the digital camera in individual files; and
wherein, when a predetermined number of the still images are stored in the image memory, the predetermined number of still images are transmitted together at one time to the mail server as the attachment file of the e-mail.

7. The information output service system according to claim 1, wherein:
the portable terminal further has the function of photographing moving images with a digital camera, and the function of transmitting moving images photographed by the digital camera to the mail server as the attachment file of the e-mail.

8. The information output service system according to claim 7, wherein:
the moving images photographed by the digital camera are continuously transmitted to the mail server as the attachment file of the e-mail while the digital camera is performing the operation of photographing the moving images.

9. The information output service system according to claim 1, wherein:
each of the fixed terminals further comprises a data recorder for recording the contents of the e-mail or the attachment file on a recording media including one of a digital videotape, a CD-R, and a DVD.

10. The information output service system according to claim 1, further comprising:
a Web site for obtaining an account for using the mail server,
wherein, when obtaining the account at the Web site, the user is charged for the use of this system.

11. The information output service system according to claim 1, wherein:
each of the fixed terminals further comprises a display, and
wherein, an advertisement is displayed on the display of the fixed terminal when the fixed terminal is idle.
